(19) United States
(12) Patent Application Publication
(10) Pub. No.: US 2006/0282325 A1
(43) Pub. Date: Dec. 14, 2006

(54) "Found and returned": a business system for the return of found items by selling guarantee of pre-paid service and shipment

(76) Inventor: Peter Martin, Grapevine, TX (US)

Correspondence Address: Peter Martin, 2967 Cripple Creek Trail, Grapevine, TX, 76051, US

(21) Appl. No.: 11/439,894

(22) Filed: May 24, 2006

Related U.S. Application Data
(60) Provisional application No. 60/684,713, filed on May 26, 2005.

(51) Int. Cl. G06Q 30/00

(52) U.S. Cl. 705/14

(57) ABSTRACT

The invention is a method of doing business by which a Guarantee of services and shipment is sold at retail, by contract, or on open account by a business entity, hereafter referred to as the Guarantor. The Guarantor engages in the business of selling guarantees of pre-paid service or pre-paid shipment to another entity such as a person, company, association, government agency, or other entity hereafter known as Customer. When an item of a type covered under the guarantee and bearing a marker of a valid guarantee is presented to the Guarantor, the Guarantor will provide services and shipment resulting in the return of that item to the purchaser of the guarantee.

This Non-Provisional Patent Application claims the benefit of U.S. Provisional Patent Application No. 60/684,713 filed May 26, 2005

### 1. FIELD OF THE INVENTION

The invention is directed toward a method of business by which a Guarantee of services and shipment is sold at retail, by contract, or on open account by a business entity, hereafter referred to as the Guarantor.

The Guarantor engages in the business of selling guarantees of pre-paid service or pre-paid shipment to another entity such as a person, company, association, government agency, or other entity hereafter known as Customer.

The Guarantor, through the guarantee, would promise to perform specific tasks, make specific payments, and to be responsible for limited costs as defined by the terms and conditions of the guarantee, should a specific condition arise.

That condition is: When an item of a type covered under the guarantee and bearing a “marker” of a valid guarantee is presented to the Guarantor, the Guarantor will provide services and shipment resulting in the return of that item to the purchaser of the guarantee, the Customer, and payment of a reward to the person or entity that presents the item to the Guarantor.

The Guarantor would make all reasonable efforts within the scope of the terms and conditions of the guarantee to return the item to the Customer and to pay a reward to the person or entity presenting the item to the Guarantor.

### 2. BACKGROUND OF THE INVENTION

People find things every day and there are thousands of collection points in every major city around the globe for found items—drawers at grocery stores, large hampers of clothes and gear at schools, boxes in management offices, or under the cash drawer.

The problem is that unless a thing found can be linked with sufficient information to return it, the person, business, or organization that finds it won't know how to proceed.

Then, of course, there's the matter of whether someone will ever get around to trying. As a practical matter, even honest, well-meaning people need an incentive other than “doing the right thing” to act.

The public at large would benefit greatly from a pre-paid commercial system by which found items could be returned to their owners that rewards the finder.

Just such a system is the subject of the present invention. This system would provide a useful, confidential, and safe means of returning found items.

### 3. SUMMARY OF THE INVENTION

The present invention is a system and method of doing business based on the offer and purchase of a guarantee of services and shipment; the provision of a marker the notice or advertising of the guarantee on an item covered; fulfillment of services and shipment; the payment of rewards according to the terms of the guarantee; and the products, services, and methods resulting in a business system for the return of found items.

The purpose of this business system is to provide methods, products, guarantees, and services that would enable people, companies, government agencies, or other entities, hereafter known as “customer” to mark physical everyday items, hereafter known as “item”, so that, if found, those items might be returned in an efficient and expedient manner. This system and method is a pre-paid “found and returned” business system.

The person, business, or other entity that contacts the system and arranges return of the item is hereafter known as “Finder”.

This business system would provide methods by which a customer can link an item to a purchased guarantee so that if an item displaying a guarantee marker is presented to the business system, the customer is notified of an item having been presented to the business system, the item is returned to the customer, and a reward paid to the finder.

According to the first embodiment of the present invention, the Guarantor is a business entity, hereafter known as the “Found and Returned” business system or “System”, that would issue and control guarantees.

The guarantees would be the promise of the business entity Guarantor to perform specific tasks either directly or through an agent, make specific payments, and to be responsible for defined and limited costs, should a specific circumstance arise, in exchange for the purchase of the guarantee by a customer from the Guarantor.

That specific circumstance is when an item bearing the mark of a valid guarantee is presented to the Guarantor (system). The System (guarantor) would provide services and shipment and make all efforts to return the item to the purchaser of the guarantee and to pay a reward to the Finder according to the terms and conditions of the guarantee.

According to the second embodiment of the present invention each guarantee is identified with an “identifying string” or “key”, hereafter known as “GIS” for “guarantee identifying string”.

A “GIS” is a combination of numbers, letters, symbols, or string sequences that together uniquely identify a guarantee issued by the Guarantor.

According to the third embodiment of the present invention, a customer would buy at retail, order by mail or across the internet, buy in bulk, be provided by contract or on an open account, or otherwise be provided with one or more guarantee markers or identifiers such as, but not limited to—rings, tags, fobs, devices, pins, labels, software, printing, or other marking device; hereafter known as “guarantee marker” or “guarantee identifier” simply “marker” or “identifier”.

According to the fourth embodiment of the present invention, a “Found and Returned” System guarantee “marker” bears a “GIS” and is manufactured specifically for the System or under license or contract with the System to inform anyone who might find an item to which it is attached that the item is covered under the “Found and Returned” System, that a reward is offered for its presentation of the item to the System, to identify the specific guarantee under which the item is covered, and to inform the finder how to contact the System.

To identify the specific guarantee under which the item is covered, a “marker” displays, presents, transmits, and makes accessible a guarantee identifying string or GIS using printed, raised, etched, stamped, or engraved symbols; or bar codes, RFID, software, or electronic display.

According to the fifth embodiment of the present invention, System “keys” or “identifying strings” (GIS) are created, issued, and controlled by the System as an arbitrary means of representing guarantees, controlling related revenues and liabilities, and connecting a guarantee to a customer through computer database record creation and queries.

The purpose of manufacture, distribution, and sale of markers or identifiers with identifying strings or keys is to provide a means for the System to link a guarantee of service, shipment, and reward for presentation of an item.

The customer creates a link to a guarantee when the customer purchases the guarantee at retail, wholesale, bulk, by contract, trade of services, or subscription and provides information sufficient to facilitate the return of an item by the System.

The customer creates a link to an item when the customer physically attaches a marker or identifier bearing the “GIS” of a guarantee purchased to an item that the customer wants returned if found.

According to the sixth embodiment of the present invention, a marker or identifier bears a “GIS”, notifies whoever reads it that the item to which it is attached or incorporated within is eligible for return through the System, and that payment of a reward to the finder according the guarantee the marker represents. The marker also provides information necessary to make contact with the “found and returned” System.

According to the seventh embodiment of the present invention, a marker or identifier could be incorporated within an item, attached to it, or otherwise travel with the item.

A marker or identifier may be attached to an item or incorporated within an item at the time of manufacture in anticipation of future participation in the System or as part of an existing contract with the System.

A marker or identifier can be of any material and design or software that would display the information elements of a guarantee marker.

According to the eighth embodiment of the present invention, markers or identifiers may be manufactured, branded, and sold by parties other than the System's owner and service provider by contractual, license, or franchise agreement with the System.

According to the ninth embodiment of the present invention, when a customer purchases a guarantee and provides information sufficient to return a found item, a customer record is created in a computer database with that information and one or more guarantees are associated or related by the GIS (the identifying strings or keys) with the customer information.

The customer information record may include, but not be limited to, the name of person or entity; address; city; state; zip code or geographical or mail code; preferred methods of contact such as home phone, work phone, cell phone, e-mail, or any other pertinent contact methods. It may also include identification information by official documents such as driver's license, passport, vehicle registration identifiers and any other information necessary to accomplish the goals of the System.

The computer database in which a customer record is stored and maintained would have guarantees related to and associated with customer records through the GIS and this link would be used to yield by database query the information necessary to return an item found that bears a guarantee marker or identifier.

According to the eleventh embodiment of the present invention, by purchasing a marker (guarantee marker or identifier) at retail or by contract on open account, a customer purchases a pre-paid voucher from the System for services, shipment of the item to the customer, and payment of a reward for the item to which it is attached if found and presented to the System. The exact guarantees, terms, benefits, and limitations of the pre-paid voucher for shipment would be expressed on the retail packaging or in the contract for the marker or identifier.

According to the twelfth embodiment of the present invention, by purchasing a guarantee marker or identifier at retail or by contract, a customer enters into a contractual agreement with the System for handling and shipment of the item to the customer, and payment of a reward for the item to which it is attached if found and presented to the System. The exact terms, benefits, guarantees, and limitations of the pre-paid voucher for shipment would be expressed on the retail packaging or in the contract for the marker or identifier.

According to the thirteenth embodiment of the present invention, in the case where a customer is company or larger entity, the “identifying strings” or “keys” (GIS) may be used on many markers or instances of markers depending upon the needs of the customer.

In example, single GIS could be used to identify and return multiple items under a single company or enterprise wide contractual agreement. As another example, a large customer may purchase many identical markers or print or manufacture them for their own purposes under license from the System and payments made on the basis of an annual fee or an accounting on what is actually handled on the basis of an open account, or both. Or a customer may require markers each with an identical base key that would represent a customer and a unique key representing instances of a guarantee or contract under the System.

According to the fourteenth embodiment of the present invention, the customer information and key or identifying string information and other System records would be maintained in a database with all of the normal functionality an enterprise customer database contained in a relational database management system including security, secure and authorized access, restriction of unauthorized access, record creation, deletion, edit, reporting, enforcement of business rules; as well as access by remote devices using dial-up, LAN, WAN, wireless, or Internet access.

The system would include secure costumer access to facilitate return of found items by reporting status, location, stage of return, the identity of the finder, and status of payment of reward, and any other pertinent information.

According to fifteenth embodiment of the present invention, a reward would be paid to the finder upon return of an item.

A basic level of reward could be created either by pre-payment, promissory note, agreement to pay, posting of a credit card by the customer with an agreement to pay, or by pooling of risk, like insurance.

The cost of the reward would be included in the sale of the guarantee to the customer or in the open account agreement or in a contract.

For customers who want to create a larger incentive for an item, a greater reward would be available for purchase or by agreement between the customer and the System.

The amount of the reward to be paid and the price would be set either functionally as a matter of marketability or from an assessment of actuarial risk, like an insurance policy, with an amount (purchase price or payment by agreement) collected necessary to pay out the reward and make a reasonable profit.

The amount of basic reward paid for the presentation of an item to the System without an additional purchase of a higher level of reward could be a calculated amount based on actual presentations and reward payments, funds available, and outstanding risk to the System.

Return practices and policies would be created to prevent and discourage possible frauds.

According to the sixteenth embodiment of the present invention, a guarantee would have a limited lifetime with a known expiration date beyond which it would no longer be active.

However, the Guarantor and business system could set the lifetime of Guarantees, and markers and identifiers to meet the business needs of customers, including an indefinite expiration, such as on an open account.

However, since an item may be returned bearing an out of date guarantee identifier or marker, policies and pricing for return of items bearing markers or identifiers of expired guarantees or contracts will be published and contact with the customers of the return of the item will be attempted. In such cases, depending upon the policies established by the System, payment of a reward may be contingent upon settlement with the customer and return of the item to the customer.

According to the seventeenth embodiment of the present invention, the “found and returned” System includes methods that would allow a customer associated with a guarantee marker or identifier on an item to be easily and quickly identified, the item collected and expediently returned to the customer, and the reward paid to the finder.

An item could be reported as found to the System by phone either to an automated voice response system or to a live operator; reported found through an internet web page or similar construct or System; reported found and collected using an automated device similar to an automated teller machine with secure collection capabilities open 24 hours a day; reported found with a dedicated terminal at collection points with secure collection; or reported found filling out a form, attaching the form to a container or envelope and by putting the item in an envelope, and dropping in a secure drop box; or reported found in person at a manned collection point designated by the System.

Once the System is notified, collection and reward payment arrangements could also be made by an agent of the System in person at the location of the found item. That is, an agent of the System would travel to the location of the object to collect it for handling by the System.

According to the eighteenth embodiment of the present invention, when an item is presented to or reported to the System as found, the GIS on the guarantee marker or identifier would be looked up in guarantee information in the computer database.

When the GIS is found in the guarantee information in the computer database, the customer associated with the Guarantee would be looked up by searching the customer information in the computer database using the GIS or other system “keys” from the Guarantee information that relate the Gaurantee to the Customer.

The customer contact information yielded by the query using GIS and the customer lookup by guarantee would be made available to authorized agents of the System in order to facilitate the shipment of the found item; payment of reward; and the computation, billing, and collection of any additional costs or fees associated with the shipment of the item to the customer.

According to the nineteenth embodiment of the present invention, the presentation to the System of an item with a valid guarantee marker or identifier by a finder would cause the System to initiate collection and return procedures including a notification of the customer that an item has been found bearing a guarantee identifier associated with the customer.

This notification could be accomplished using a live operator, telephone notification using a voice response system, e-mail, either manually or using a computer System or all of the above.

Such a notification could also include location of the item, method of reporting and collection, and a preliminary assessment of the condition of the item, with information that would allow the customer to choose an appropriate course of action and pay any associated costs additional to the guarantee purchase cost to accomplish the recovery and return of the item by shipment or otherwise.

The customer may request to pick the item up in person at a System collection point or request that the item be shipped to the customer or specify and empower a third party to receive the found item.

According to the twentieth embodiment of the present invention, a specialized, single purpose computer device or computer program would, as an option, be distributed to point of sale and point of return venues to provide secure database terminal services for the System.

Through the functionality, services, I/O, and communications capability provided by the device or program, an authorized user would be able to make and record a sale of a guarantee. The authorized user would also be able to associate that guarantee with customer information; collect payment for a sale of guarantee, markers, identifiers, rewards, additional shipping and handling costs, or other fees; collect a lost item; make reward arrangements; and do all customer service transactions associated with the System.

Using the device or program, an authorized user would be able to report an item as found, lookup customer information, initiate a system action such as an item collection; initiate or fulfill notification or customer; create a shipment; print shipping labels or identification and handling labels; create bills of lading for found items; record payment of a reward or make reward arrangements; send an unclaimed or item with information insufficient to ship to a central holding or salvage facility; or any other function within the found and returned system.

According to the twenty-first embodiment of the present invention, a key or identifying string (GIS) used to identify a guarantee, prepaid service, prepaid shipping, marker, identifier, or customer may be made assigned to one or more markers or identifiers at the time of a sale.

A GIS may be requested from the System and provided to the point of sale in order to be applied to a blank marker. The assigned key or identifying string (GIS) may then be made available for display or transmission on the markers or identifiers at the time a marker or identifier is sold.

For instance, at the time of sale, a metal or plastic or carbon fiber ring marker that would display the key or identifier would be engraved or etched with the key or identifying string; or an RFID identifier would be programmed to transmit a key or identifying string and a printed label placed on the device to visually mark the device; or a label might be produced with a key or identifying string that is then sealed and placed on a tether or ring; or a piece of software would be configured with a key or identifying string.

In all cases, the assignment of the key or identifying string of the guarantee or prepaid voucher for service or shipment is determined by communication (request for the GIS and reply with the GIS) with the System at the time of sale whether by telephone to an automated system or customer service representative, computer, dial-up, web page, or internet access and the keys and identifying strings are applied to the marker or identifier.

According to the twenty-second embodiment of the present invention, the amount of reward may be displayed on the marker or identifier of guarantee, prepaid service or shipping vouchers; In addition, the reward amount may be displayed on an additional device. For instance, to identify the guarantee or voucher an attached ring (marker) might be engraved with the key or identifying string and an additional ring, color-coded by reward ring displays (engraved or otherwise) the level of reward offered.

According to the twenty-third embodiment of the present invention, the Guarantor plans, authorizes the sale of, and issues guarantees, prepaid service vouchers, or prepaid shipment vouchers.

In order to track the liabilities and revenues associated with the sale and fulfillment of the guarantees or items or markers, the Guarantor creates “keys” or “identifying strings” (GIS). The guarantee identifying strings are created using naming and numbering conventions adopted by the Guarantor and represent the Guarantees or vouchers on a one to one basis. (See Found and Returned Business System Logical Model, Guarantees table.)

The GIS are stored in a computer database either by being keyed into the database records or generated by a computer program or stored procedure and stored in database records.

When the keys are assigned and supplied to manufacturers or licensees to produce “markers” and “identifiers” for the “Found and Returned” System, the records in the computer database holding marker and manufacturer information are updated with either data into the record designating the manufacturer assignment and GIS assignment or with a foreign keys that relate the record as a child of a parent tables. The marker inventory information describes which manufacturer the GIS was assigned and supplied to. (See Found and Returned Business System Logical Model, Guarantees, Manufacturer, Marker Type, and Marker Inventory tables.)

At the time of manufacture and delivery both blank markers (No GIS assigned) and markers bearing GIS tracked from manufacture to retail sales outlet using manufacture, packing, and shipment information and stored in the computer database. A master manufacturing record including order number, purchase order number, contract for sale number, retail company, retail store number or description, date of shipment, order number, ship to address, date of delivery, person signing for shipment, shipment account, and receivables value of shipment is created. Related manufacturing detail records containing the master carton designation, pallet designation, key value range or list of master carton, key value by marker, marker or identifier type, manufacturer, date of manufacture would also be created. The relationship between the master record and the detail record would be parent to child with one to many, the master being one, the child being many. The records would also contain any other information pertinent to the chain of supply to retail outlets. The relationship between retail outlets and keys would be one to many, retail outlets as the parent, keys as child, and one retail outlet to many unique keys. (See Found and Returned Business System Logical Model, Marker Inventory and Retail Sales tables.)

Should retail packages be pilfered, damaged, or unsalable and the items “returned” (within the business system), the key or identifying strings records would flagged as returned from retail, the use of the key within the “Found and Returned System voided, and the values of guarantees and accounts receivables adjusted. This same database procedure could be used when a marker or identifier is returned when reversing or voiding a sale

When a marker or identifier bearing GIS at retail, customer information is captured either at the point of sale by the seller and supplied to the System as part of a sales record or by a customer service function of the System at some later time. (See Found and Returned Business System Logical Model, Retail Sales Record and Customer tables.)

When a marker or identifier is supplied directly to the customer by the System under an open account or contract, customer information is supplied to the System. (See Found and Returned Business System Logical Model, Customer table.)

The customer information is stored in a computer database and is related to a Guarantee (and alternately, the marker or identifier information) either with data in the record itself—the GIS—or with a foreign key that relates the customer as the parent to the child table of identifiers and keys designating a relationship of many guarantees to one customer. (See Found and Returned Business System Logical Model, Guarantees and Customer tables.)

Additionally, when a marker is sold at retail, a sales record is made based on either sales reports from the retail company or in batch capturing the value of the sale including but not limited to retail company, retail store, GIS on marker of supplied by the System and applied, marker type, reward, additional reward amount, date of sale, time of sale, expiration date, subtotal amount, tax amount, total amount, method of payment, and customer information. (See Found and Returned Business System Logical Model, Retail and Retail Sales Detail tables.)

The sale of a Guarantee creates a potential liability for the System for the costs associated with the handling and shipment in returning items to customers as well as payment of a reward. These potential liabilities could be stored in guarantee information or in separate or summary tables. The liability records would have a one to one relationship with guarantee records.

The reward amount associated with a sale can be set arbitrarily at this point either as an absolute amount or a “level” to be paid out based on customer base, prior use of the fund, and an actuarial assessment of future liabilities.

A sale would trigger the creation of some record of reward either as data entered into the sales record, guarantee, or the key or identifying string record or as a record of the reward related one to one to guarantee, key or identifying string, or retail.

A sale of additional higher reward for return of covered item bearing a marker would trigger the creation of some record of reward either as data entered into the sales record, guarantee, or the key or identifying string record or as a record of the reward related one to one to guarantee, key or identifying string, or retail. (See Found and Returned Business System Logical Model, Guarantees and Finder Rewards tables.)

When the return is complete the key or identifying string is marked for completed return and voided for future use.

When the return is complete and the reward is paid the key or identifying string is marked for completed return with reward paid and record created recording the payment of the reward. (See Found and Returned Business System Logical Model, Finder Rewards and Guarantee tables.)

When the guarantee or key or identifying string reaches the end of its designated valid period the guarantee or key or identifying string record would be flagged as expired. The System could use the pending expirations to sell renewals or new guarantees and markers to customers. (See Found and Returned Business System Logical Model, Guarantees and Customer tables.)

### 4. BRIEF DESCRIPTION OF THE DRAWINGS

FIG. 1 shows the business process of the manufacture and sale of “Found and Returned” System identifiers, the purchase of identifiers by customer, the marking of items the customer considers valuable with the identifier, and the association of identifier information with customer information in the Customer and Identifier information database.

FIG. 2 shows the business process of recognition of an item as participating in the “found and returned” System, collection of found items by the System, and the identification of a found item as associated with a customer through the lookup of an identifier in the customer and identifier database; and payment of the reward to the finder after an item is collected.

FIG. 3 shows the business process of notification and return of the item associated with the identifier to the customer.

FIG. 4 is a restatement of the business process depicted in FIG. 3 in terms referring to a computerized system.

FIGS. 5, 6, and 7 show the Found and Returned Business System Logical Data Model and data relationships in IDEF1X notation.

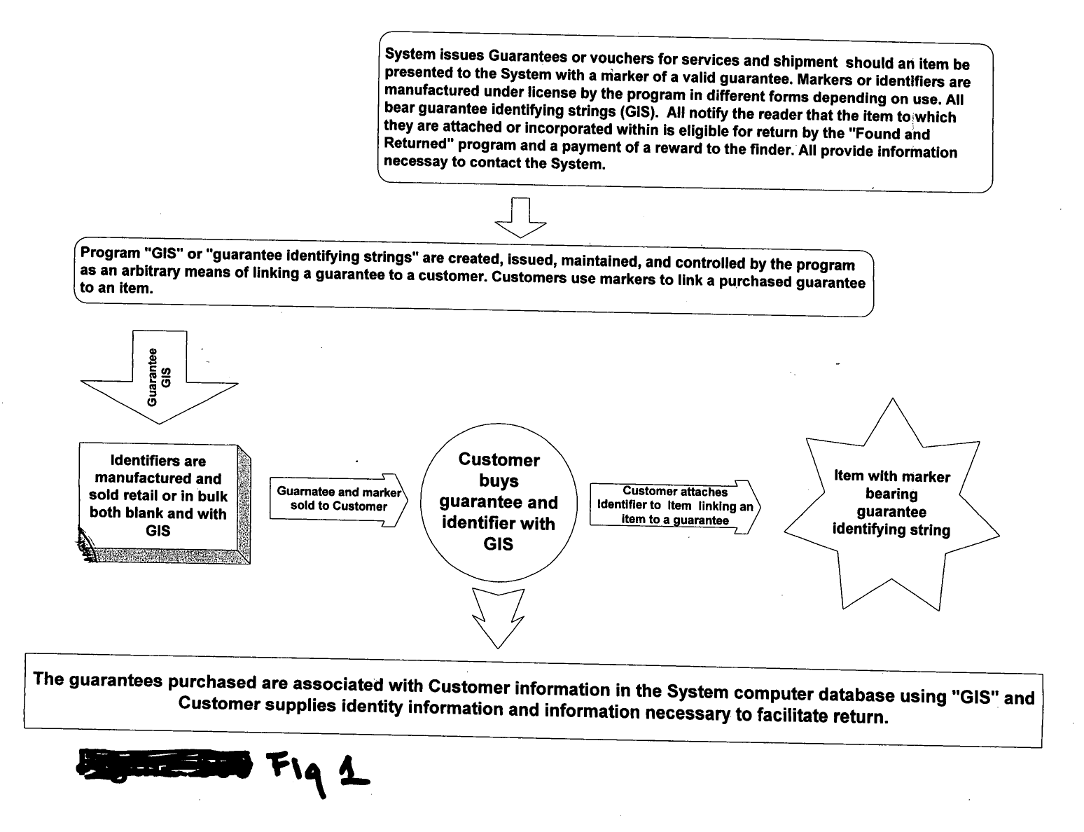

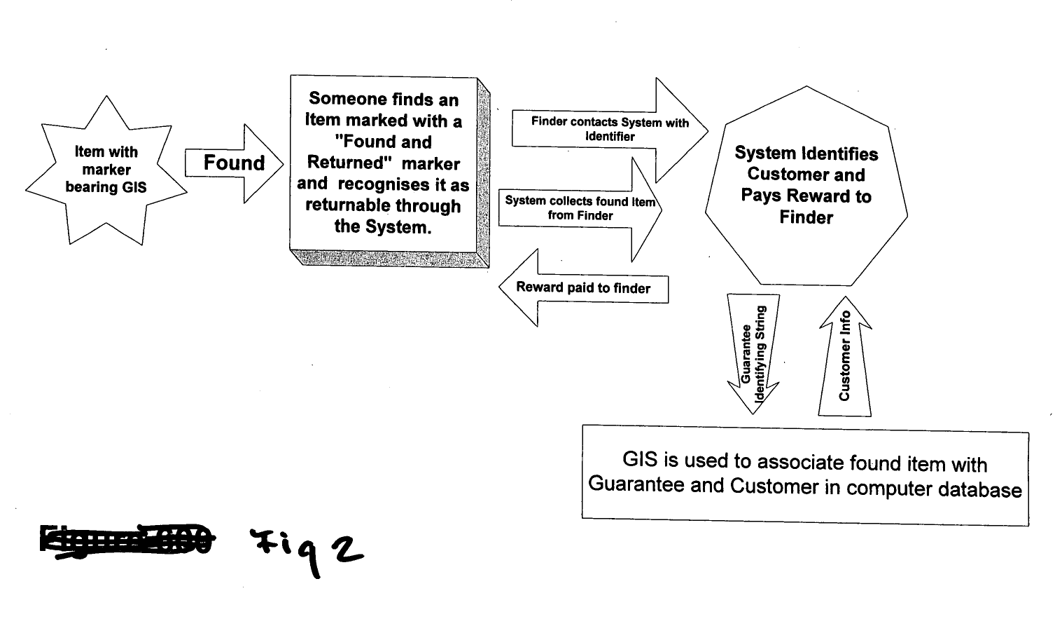

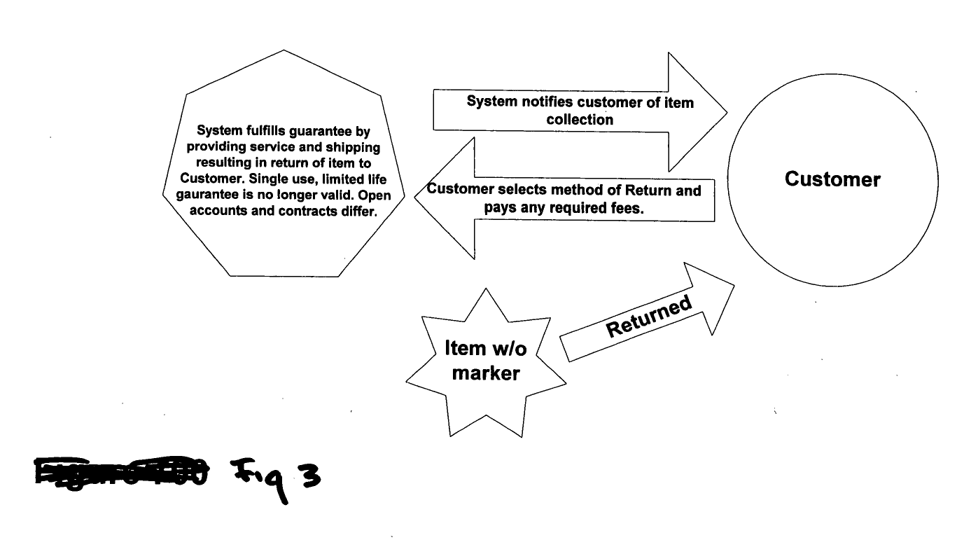

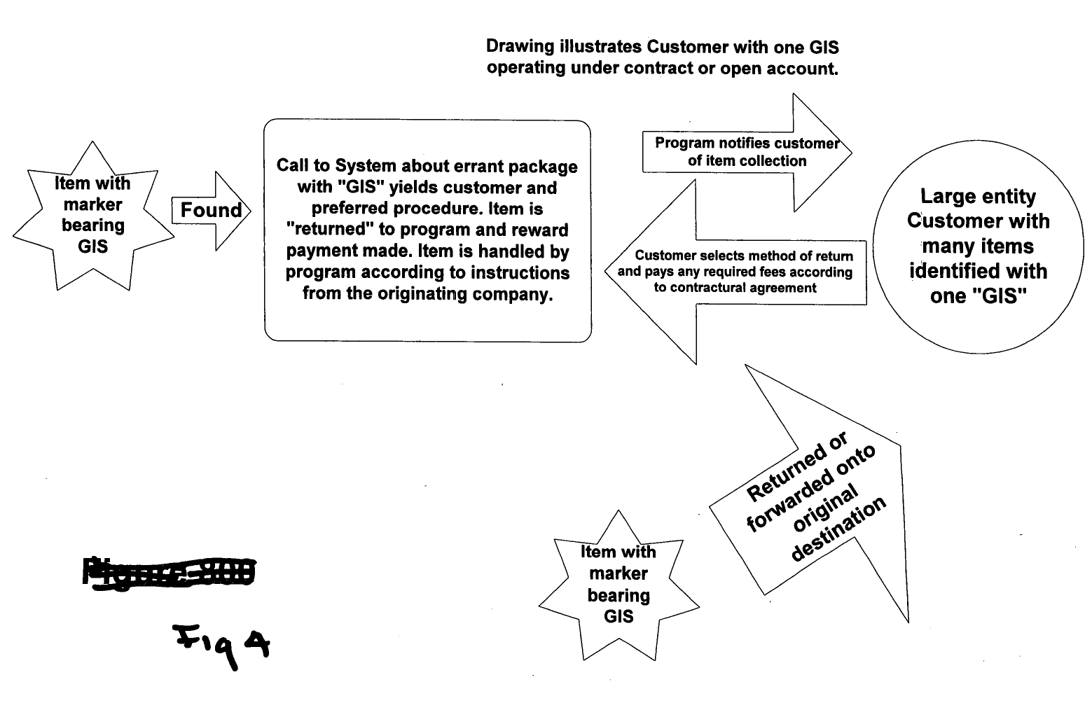

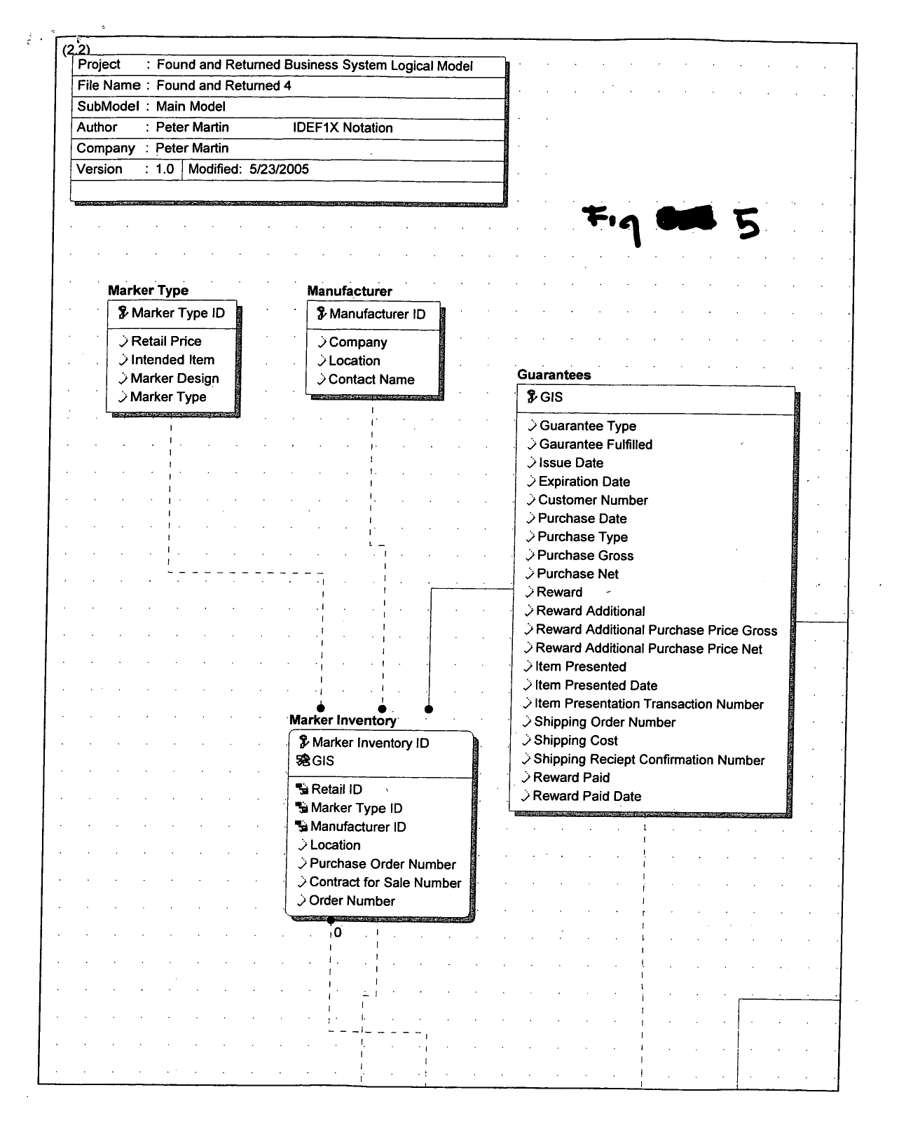

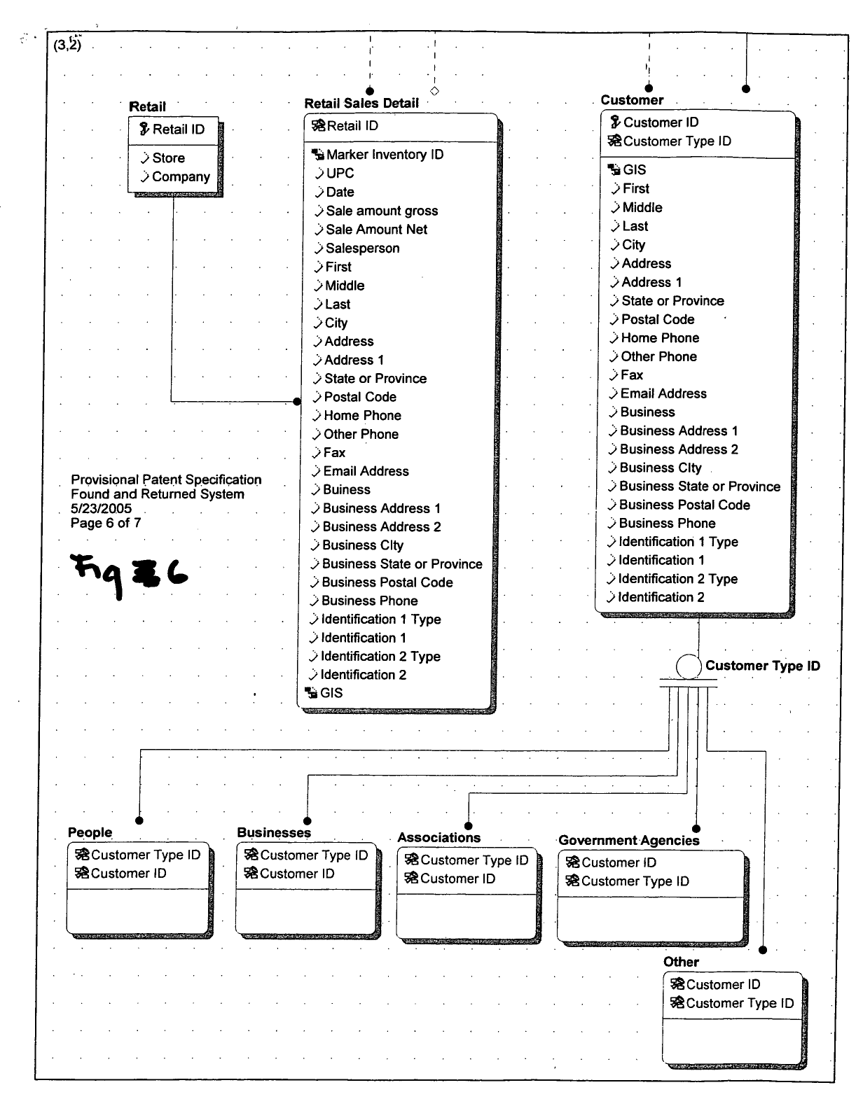

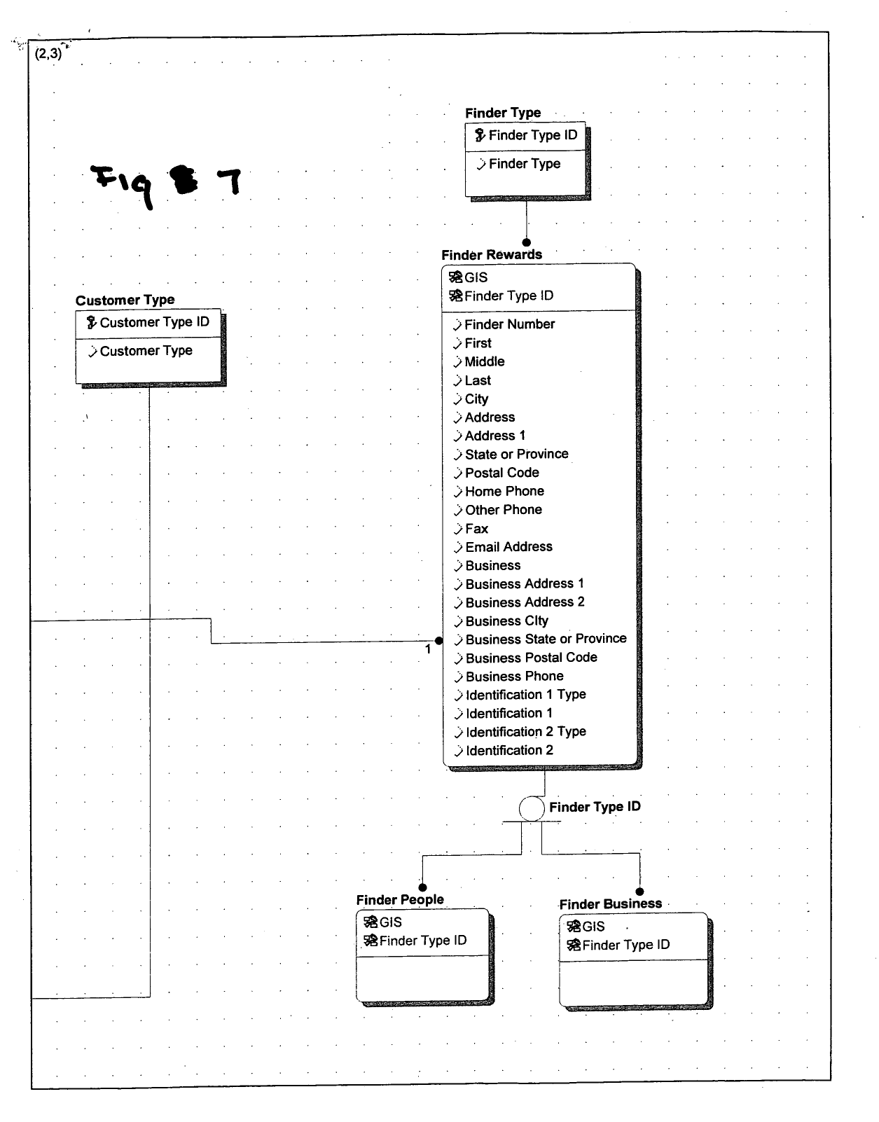

1. A system and method of doing business comprising the steps of:
creation and issuance of a guarantee of pre-paid service and shipment for items found by or delivered to the guarantor or guarantor's agent with a guarantee identifier or marker to the purchaser of the guarantee and associated identifier(s);
sale of a guarantee of service either at retail, wholesale, bulk, by contract, trade of services, or subscription together with identifiers that advertise a guarantee, reward, and method of contacting the guarantor;
acceptance, pick-up, or taking delivery of an item marked with a guarantee of pre-paid service and shipment and delivery of the item to the purchaser of the guarantee;
and payment of reward to the finder of the item with the guarantee.

2. A system and method of doing business further comprising the steps of
associating a guarantee with an identifying string and in turn identifying the identifying string with an identifier,
an identifier being an object or software that in some way is attached or travels with an item;
and the guarantor when presented with a guarantee identifier attached to an item, looks up the purchaser of the guarantee, and provides services and shipment directly or through an agent resulting in the delivery of the item to the purchaser of the guarantee.

3. A system and method of doing business further comprising the steps of
payment of a reward to the person or other entity that places an item found with a guarantee identifier into the possession of the guarantor.
